(19) United States
(12) Patent Application Publication
(10) Pub. No.: US 2025/0260003 A1
(43) Pub. Date: Aug. 14, 2025

(54) COATED ACTIVE MATERIAL AND COATED ACTIVE MATERIAL PRODUCTION METHOD

(71) Applicant: TOYOTA JIDOSHA KABUSHIKI KAISHA, Toyota-shi (JP)

(72) Inventor: Masaru KUBOTA, Okazaki-shi (JP)

(73) Assignee: TOYOTA JIDOSHA KABUSHIKI KAISHA, Toyota-shi (JP)

(21) Appl. No.: 19/042,238

(22) Filed: Jan. 31, 2025

(30) Foreign Application Priority Data
Feb. 14, 2024 (JP) 2024-020666

(51) Int. Cl. H01M 4/36; H01M 4/02; H01M 4/04; H01M 10/0562

(52) U.S. Cl. CPC H01M 4/366; H01M 4/0407; H01M 4/0419; H01M 10/0562; H01M 2004/021; H01M 2300/0071

(57) ABSTRACT

The coated active material includes an electrode active material and a coating layer covering the electrode active material, wherein the coating layer includes an oxide solid electrolyte containing a Li element, a P element, and an O element, and a particle size (D₅₀) of the coated active material is 5.5 μm or less.

### CROSS-REFERENCE TO RELATED APPLICATION

This application claims priority to Japanese Patent Application No. 2024-020666 filed on Feb. 14, 2024, incorporated herein by reference in its entirety.

### BACKGROUND

### 1. Technical Field

The present disclosure relates to a coated active material and a coated active material production method.

### 2. Description of Related Art

In recent years, development of batteries has been actively pursued. For example, batteries for use in battery electric vehicles (BEVs), plug-in hybrid electric vehicles (PHEVs), or hybrid electric vehicles (HEVs) have been developed in the automotive industry. It is known to coat a surface of an electrode active material for use in batteries with a coating layer.

For example, Japanese Unexamined Patent Application Publication No. 2023-136763 (JP 2023-136763 A) discloses a composite particle including a positive electrode active material particle and a coating film that coats at least a part of a surface of the positive electrode active material particle and that contains a phosphorus compound. Furthermore, J P 2023-136763 A discloses producing a composite particle by mixing a positive electrode active material particle and an aqueous coating liquid (aqueous coating liquid) containing phosphorus and drying the mixture.

### SUMMARY

From the viewpoint of chemical stability and ionic conductivity of the coating film (coating layer), it has been studied to use phosphorus (P) in the coating layer. On the other hand, a compound that is used as a phosphorus source such as phosphoric acid, for example, has high viscosity and tends to be aggregated when forming a coating layer, and there is a possibility that the particle size of the coated active material increases. When the particle size of the coated active material increases, the battery resistance may increase.

The present disclosure has been made in view of the above circumstances, and has a main object to provide a coated active material capable of suppressing an increase in battery resistance.

[1]

A coated active material including an electrode active material and a coating layer that coats the electrode active material, in which:
the coating layer contains an oxide solid electrolyte containing an Li element, a P element, and an O element; and
a particle size (D₅₀) of the coated active material is 5.5 μm or less.
   [2]

The coated active material according to [1], in which
the particle size (D₅₀) is 1.0 μm or more.
   [3]

The coated active material according to [1] or [2], in which
the oxide solid electrolyte further contains a B element or an La element.
   [4]

A coated active material production method of producing the coated active material according to any one of [1] to [3], including:
preparing a slurry containing the electrode active material, the oxide solid electrolyte, and a solvent for dissolving the oxide solid electrolyte; and
forming the coating layer by a spray drying method of jetting the slurry with atomized air to be dried, in which
a gas-liquid ratio in the spray drying method is 5.0×10⁻³ or less.
   [5]

The coated active material production method according to [4], in which the atomized air has a flow rate of 60 L/min or more.

According to the present disclosure, it is possible to provide a coated active material capable of suppressing an increase in battery resistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a coated active material in the present disclosure;

FIG. 2 is a schematic cross-sectional view illustrating a battery in the present disclosure;

FIG. 3 is a flowchart illustrating a coated active material production method according to the present disclosure;

FIG. 4A is a graph showing the relation between the gas-liquid ratio and the particle size D₅₀ in Examples and Comparative Examples;

FIG. 4B is a graph showing a relationship between a gas-liquid ratio and a ratio of a particle size before and after forming a coating layer in Examples and Comparative Examples; and

FIG. 5 is SEM images of the coated active material prepared in Example 1.

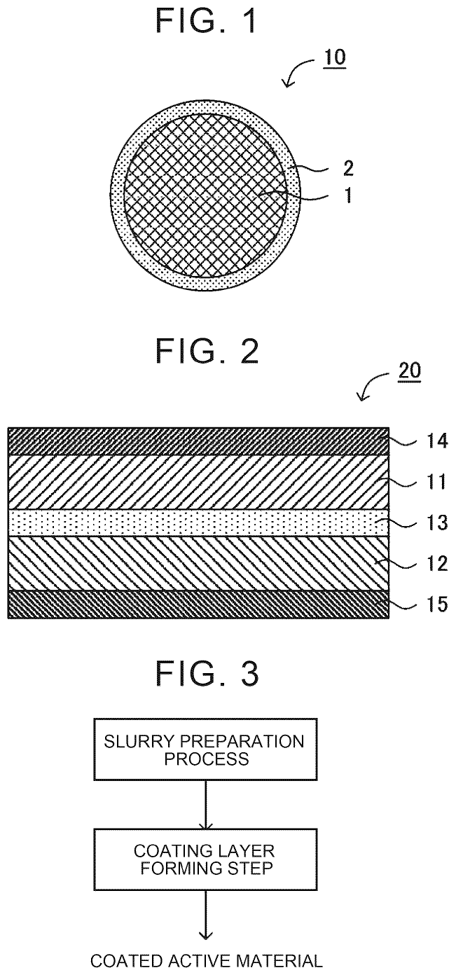

### DETAILED DESCRIPTION OF EMBODIMENTS

Hereinafter, a coated active material and a coated active material production method according to the present disclosure will be described in detail.

### A. Coated Active Material

The coated active material according to the present disclosure includes an electrode active material and a coating layer covering the electrode active material. In addition, the coating layers contain an oxide-solid electrolyte containing an Li element, a P element, and an O element. In particular, in the coated active material of the present disclosure, the particle size (D₅₀) is 5.5 μm or less.

The coated active material of the present disclosure has a particle size (D₅₀) of 5.5 μm or less, and thus can suppress an increase in battery resistivity when used in a battery.

From the viewpoint of suppressing battery resistance, the particle size of the coated active material is preferably small. This is because the contact area with the electrolyte can be increased by increasing the specific surface area of the coated active material. This is because the diffusion distance of the carrier ions in the coated particles can be reduced. On the other hand, as described above, when the coating layer contains phosphorus (P), there is a possibility that the particle size of the coated active material is increased due to granulation of the active material, and there is a problem in suppressing the battery resistance by reducing the particle size of the coated active material. In this regard, the present inventors have intensively studied conditions for producing a coated active material using a so-called spray drying method. As a result, the present inventors have found that, by setting the gas-liquid ratio in the spray-drying method to be equal to or less than 5.0×10⁻³, granulation can be suppressed, and the particle size (D₅₀) of the coated active material can be reduced. In general, when the gas-liquid ratio is decreased, the flow rate of the atomized air is relatively increased. When the flow rate of the atomized air is large, the active material can be coated in a state in which the coating liquid is sufficiently misted, so that it is considered that a uniform and thin coating layer can be formed. When the thickness of the coating layer is large, aggregation and granulation of the coated particles by phosphorus contained in the coating layer is likely to occur, the particle size of the coated active material is considered to be increased, the thickness of the coating layer is small it is considered that such aggregation can be suppressed.

Further, in the manufacture of a battery, it is assumed that the electrode layer is pressed. In this regard, when the particle size of the coated active material is increased by granulation, the coated active material is easily deformed by the pressing, and there is a possibility that cracks may occur in the electrode layer due to deformation of the coated active material, which may cause an increase in battery resistance. On the other hand, since the coated active material in the present disclosure has a small particle size, that is, since aggregation is suppressed, an increase in battery resistance caused by cracking of the electrode layer can also be suppressed.

The coated active material of the present disclosure has a particle size (D₅₀) of 5.5 μm or less. The D₅₀ may be 5.0 μm or less, 4.5 μm or less, or 4.0 μm or less. On the other hand, the D₅₀ is, for example, 1.0 μm or more, may be 2.0 μm or more, or may be 3.0 μm or more. The coated active material has a particle size (D₁₀) of not particularly limited, but is, for example, 0.5 μm or more and 3.0 μm or less. The coated active material has a particle size (D₉₀) of not particularly limited, but is, for example, 3.0 μm or more and 15.0 μm or less. Here, the particle size D₁₀, the particle size D₅₀, and the particle size D₉₀ correspond to a particle size corresponding to a cumulative 10% by volume, a particle size corresponding to a cumulative 50% by volume, and a particle size corresponding to a cumulative 90% by volume, respectively, measured by a laser diffractive particle size distribution measuring device.

Further, it is preferable that the variation in particle size in the coated active material is small. Variation in particle size can be obtained by (particle size D₅₀)/(particle size D₉₀-particle size D₁₀). The variation in particle size is, for example, 0.4 or more and 1.1 or less.

### 1. Coating Layer

The coating layer is a layer that covers the electrode active material. In addition, the coating layers contain an oxide-solid electrolyte containing an Li element, a P element, and an O element.

The ratio of Li element in the oxide solid-state electrolyte is not particularly limited, but is, for example, not less than 20 mol % and not more than 50 mol %. The proportion of the P element in the oxide solid-state electrolyte is not particularly limited, but is, for example, not less than 5 mol % and not more than 20 mol %. The ratio of the elements can be calculated, for example, by ICP (Radio Frequency Inductively Coupled Plasma) spectrometry.

The ratio of the O element can be determined as the oxygen concentration by, for example, a heat melting method. The oxygen concentration of the oxide solid electrolyte in the present disclosure, which is determined by the heat melting method, is, for example, 45 wt % or more and 60 wt % or less. The molar ratio of the O element in the oxide solid-state electrolyte is not particularly limited, but is, for example, not less than 30 mol % and not more than 60 mol %.

The oxide solid-state electrolyte may further contain an element B or an element La. The molar ratio (B/P) of the element B to the P element is not particularly limited, but is, for example, 0.5 or more and 2.0 or less. Further, the molar ratio of Li element to the sum of the P element and the B element (Li/(P+B)) is not particularly limited, for example, 0.3 or more, 1.2 or less. The molar ratio (La/P) of La element to the P element is, for example, 0.005 or more and 0.15 or less.

The coverage ratio of the coating layer with respect to the electrode active material is not particularly limited, but may be, for example, 75% or more and may be 80% or more. If the coverage is too low, there is a possibility that an increase in resistance caused by the high-resistance layer caused by the reaction of the electrode active material and the electrolyte cannot be sufficiently suppressed. On the other hand, the coverage may be 100% or less than 100%. The coverage ratio in the present disclosure is determined based on X-ray photoelectron spectroscopy (XPS) measurement. An element ratio is calculated from the intensity ratio of the main elements, and the ratio of the elements included in the coating layer to the sum of the elements included in the electrode active material and the elements included in the coating layer is determined as the ratio of elements included in the coating layer.

The thickness of the coating layers is not particularly limited, but may be, for example, 1 nm or more and 100 nm or less, 5 nm or more and 50 nm or less, or 10 nm or more and 30 nm or less. The thickness of the coating layers is determined, for example, as the mean of the thicknesses of a plurality of samples (e.g., 100 or more samples) observed by scanning electron microscopy (SEM) or transmission electron microscopy (TEM).

The coating layer may directly cover the electrode active material. On the other hand, the coating layer may indirectly cover the electrode active material. The indirect coating means that a layer containing no oxide solid electrolyte in the present disclosure is disposed between the electrode active material and the coating layer. Even in a case where a layer not containing an oxide solid electrolyte is disposed between the electrode active material and the coating layer in a portion of the coated active material, if there is a portion where the electrode active material and the coating layer are in direct contact with each other, the coating layer can be regarded as directly covering the electrode active material.

### 2. Electrode Active Material

The electrode active material includes, for example, an Li element, an M element, and an O element. M is a metal other than Li (including metalloid), preferably contains at least Ni. M other than Ni may be a transition-metal and may be a metal (including a metalloid) belonging to Groups 13 to 16 of the Periodic Table. M other than Ni may be one kind of metal or two or more kinds of metals. Among them, M other than Ni is preferably at least one of Co, Mn, Al, V, and Fe.

The molar ratio (Ni/M) of Ni to M is, for example, 80% or more, may be 85% or more, or may be 90% or more. On the other hand, Ni/M may be 100% or less than 100%.

In addition to Li element, the M element, and the O element, the electrode active material may include a non-metallic element such as a P element. The crystal structure of the electrode active material is not particularly limited, and examples thereof include a rock salt layered structure, a spinel structure, and an olivine structure.

Examples of the composition of the electrode active material include LiNiₓCo_{y}Al₂O₂ (0.80≤x, 0≤y, 0≤z, x+y+z=1), and LiNiₐCo_{b}Mn_{c}O₂ (0.80≤a, 0≤b, 0≤c, a+b+c=1).

The shape of the electrode active material is usually particulate. The particle size D₅₀ of the electrode active material is, for example, equal to or larger than 100 nm, and may be equal to or larger than 1 μm. On the other hand, the particle size D₅₀ of the electrode active material is, for example, 10 μm or less, and may be 5 μm or less.

### 3. Coated Active Material

The coated active material in the present disclosure is usually used in a battery. The coated active material may be used as a positive electrode active material in a battery, or may be used as a negative electrode active material, but the former is preferable.

FIG. 2 is a schematic cross-sectional view illustrating a battery using a coated active material according to the present disclosure. The battery 20 illustrated in FIG. 2 includes a positive electrode active material layer 11, a negative electrode active material layer 12, an electrolyte layer 13 disposed between the positive electrode active material layer 11 and the negative electrode active material layer 12, a positive electrode current collector 14 that collects current of the positive electrode active material layer 11, and a negative electrode current collector 15 that collects current of the negative electrode active material layer 12. In the battery 20, the positive electrode active material layer 11 preferably contains the above-described coated active material.

The positive electrode active material layer contains at least a positive electrode active material, and may optionally contain at least one of a conductive auxiliary agent, a binder, and an electrolyte. The positive electrode active material is preferably the coated active material described above. Conductive aids, binders and electrolytes may include common materials used in batteries. The electrolyte may be a solution-based electrolyte or a solid electrolyte, but the latter is preferable. Examples of the solid electrolyte include an inorganic solid electrolyte such as a sulfide solid electrolyte and an oxide solid electrolyte.

The negative electrode active material layer contains at least a negative electrode active material, and may optionally contain at least one of a conductive auxiliary agent, a binder, and an electrolyte. Conductive aids, binders and electrolytes are described above. Examples of the negative electrode active material include a metal active material such as Li, Sn, a Si active material, a carbon active material such as graphite, and an oxide active material such as Li₄Ti₅O₁₂.

The electrolyte layer contains at least an electrolyte, and may optionally contain a binder. The binder and electrolyte are as described above. Here, generally, a battery in which the electrolyte layer contains a solid electrolyte (for example, an inorganic solid electrolyte) is referred to as a solid battery. The solid state battery may be a semi-solid state battery or an all-solid state battery.

The positive electrode current collector and the negative electrode current collector can be members used in a general battery. Examples of the positive electrode current collector include SUS, aluminum, nickel, iron, titanium, and carbon. On the other hand, examples of the negative electrode current collector include SUS, copper, nickel, and carbon.

The coated active material production method is not particularly limited, but the method described in “B. Coated Active Material Production Method” is preferable. B. Coated Active Material Production Method

FIG. 3 is a flowchart illustrating a coated active material production method according to the present disclosure. In the manufacturing method shown in FIG. 3, a slurry containing an electrode active material, the oxide solid electrolyte, and a solvent for dissolving the oxide solid electrolyte is prepared (slurry preparation step). Next, the coating layer is formed by a spray drying method in which the slurry is sprayed with atomized air and dried (coating layer forming step). In the present disclosure, the coating conditions are adjusted so as to obtain the coated active material described in the above “A. coated active material”. In particular, in the spray-drying method in the coating layer forming step, the gas-liquid ratio is adjusted to be equal to or less than 5.0×10⁻³.

According to the present disclosure, by adjusting the gas-liquid ratio to be equal to or less than 5.0×10⁻³, a coated active material having a particle size (D₅₀) of 5.5 μm or less can be produced.

### 1. Slurry Preparation Process

The slurry preparation step is a step of preparing a slurry containing an electrode active material, the oxide solid electrolyte, and a solvent that dissolves the oxide solid electrolyte. The electrode active material and the oxide-solid electrolyte are the same as those described in the “A. coated active material”.

The solvent is not particularly limited as long as the oxide solid electrolyte can be dissolved. Examples of the solvent include water.

Slurry, for example, a raw material of the oxide solid electrolyte (e.g., Li source, B source, P source, La source and O source) to prepare a coating liquid dissolved in water, the electrode active material in the coating liquid it can be prepared by adding and mixing.

Li source is not particularly limited as long as it is a single substance or a compound having an Li element, and examples thereof include lithium hydroxide (LiOH). The B source is not particularly limited as long as it is a single substance or a compound having element B, and examples thereof include boric acid (H₃BO₃). The P source is not particularly limited as long as it is a single substance having a P element or a compound, and examples thereof include orthophosphoric acid (H₃PO₄) and metaphosphoric acid (HPO₃). La source is not particularly limited as long as it is a single substance having an La element or a compound, and examples thereof include lanthanum oxide (La₂O₃). Examples of the O source include an O element included in the above-described element source.

Further, the solid content concentration in the slurry is not particularly limited, and it is preferable to appropriately adjust the concentration so as to obtain a gas-liquid ratio to be described later. The solid content concentration of the slurry is, for example, 50 wt % or more and 70 wt % or less.

### 2. Coating Layer Forming Step

The coating layer forming step is a step of forming a coating layer by a spray drying method. More specifically, the coating layer is formed by spraying and drying the slurry together with atomized air. In particular, in the coating layer-forming step of the present disclosure, the gas-liquid ratio is adjusted to be equal to or less than 5.0×10⁻³. The coating layer forming step in the present disclosure corresponds to a so-called wet coating.

The gas-liquid ratio may be equal to or less than 3.0×10⁻³, equal to or less than 1.0×10⁻³, or equal to or less than 5.0×10⁻⁴. On the other hand, the gas-liquid ratio is, for example, 1.0×10⁻⁴ or more. The gas-liquid ratio can be determined as a ratio of the water feed amount (L/min) to the flow rate (L/min) of the atomized air.

The flow rate of the atomized air is not particularly limited as long as the gas-liquid ratio is obtained, but may be, for example, 60 L/min or more, 100 L/min, or 300 L/min or more, or 1000 L/min or more. On the other hand, the flow rate of the atomized air may be, for example, equal to or less than 2500 L/min and equal to or less than 2000 L/min.

The water feed (L/min) can be determined, for example, by the following equation:

Water Feed=[Slurry Feed Rate (L/min)]×[1−(Solid Concentration (%)/100)]

The amount of water supplied is not particularly limited as long as the gas-liquid ratio is obtained, but may be, for example, 0.10 L/min or more, 0.50 L/min or more, or 1.0 L/min or more. On the other hand, the water content may be, for example, less than or equal to 10 L/min, less than or equal to 5.0 L/min, or less than or equal to 3.0 L/min.

The powder obtained through the coating layer forming step may be fired. This is because the crystallinity of the oxide solid electrolyte in the coating layer can be enhanced. The firing temperature is not particularly limited, but is, for example, 500° C. or higher and 1000° C. or lower. The firing time is not particularly limited, but is, for example, 30 minutes or more and 20 hours or less.

### 3. Coated Active Material

The coated active material produced through the above-described steps is the same as the content described in the “A. Coated Active Material”.

Note that the present disclosure is not limited to the above-described embodiment. The above embodiments are illustrative, and anything having substantially the same configuration as, and having similar functions and effects to, the technical idea described in the claims of the present disclosure is included in the technical scope of the present disclosure.

### Example 1

### Preparation of Coating Liquid

A coating solution for coating layers containing an oxide solid-electrolyte containing Li, P, B, and O elements was prepared as follows.

First, a metaphosphate (Fujifilm Wako Pure Chemical Industries, Ltd.) 4.52 g was dissolved in an ion-exchanged water 191.8 g. Boric acid (manufactured by Nacalai Tesque) was then added and dissolved so that the molar ratio (B/P) was 1.0. Further, lithium hydroxide monohydrate (manufactured by Fujifilm Wako Pure Chemical Industries, Ltd.) was added and stirred so that the molar ratio (Li/(P+B)) was 1.00.

### Preparation of Coated Active Material

An active material (NCA: LiNi_{0.81}Co_{0.15}Al_{0.04}O₂; particle size D₅₀: 2.9 μm) was dispersed in the coating liquid to obtain a slurry. The slurry was additionally diluted with ion-exchanged water to adjust the solid concentration. The obtained slurry was dried using a spray drying apparatus to obtain a solid component. The conditions of spray drying were such that the supply air temperature was 200° C., and the flow rate (air flow rate) and the water supply amount of atomized air were the values listed in Table 1. The water supply amount was calculated by the above-described calculation formula. Then, the obtained solid component was heat-treated at 200° C. for 5 hours in an air atmosphere. Thus, a coated active material was obtained.

### Examples 2 to 8 and Comparative Example 1

As shown in Table 1, a coated active material was obtained in the same manner as in Example 1, except that the particle size of the active material and the conditions for forming the coating layer (conditions for spray drying) were changed. The water supply amount was adjusted by changing the solid concentration of the slurry.

TABLE 1

| | | | Coating Layer | | |
|---|---|---|---|---|---|
| | | | Forming Conditions | | |
| | Active | | | Air | |
| | Material | Solid | Water | Flow | Gas- |
| | Particle | Electrolyte | Supply | Rate | Liquid |
| | Size | Contained | X | Y | Ratio |
| | (D₅₀: μm) | Element | (L/min) | (L/min) | (X/Y) |
| Comparative | 2.9 | Li, B, P, O | 0.61 | 120 | 5.1 × 10⁻³ |
| Example 1 | | | | | |
| Example 1 | 2.9 | Li, B, P, O | 0.15 | 320 | 4.7 × 10⁻⁴ |
| Example 2 | 2.9 | Li, B, P, O | 0.15 | 220 | 6.8 × 10⁻⁴ |
| Example 3 | 2.9 | Li, B, P, O | 0.18 | 320 | 5.6 × 10⁻⁴ |
| Example 4 | 2.9 | Li, B, P, O | 0.16 | 320 | 5.0 × 10⁻⁴ |
| Example 5 | 3.1 | Li, B, P, O | 7.4 | 1820 | 4.1 × 10⁻³ |
| Example 6 | 3.1 | Li, B, P, O | 2.0 | 1820 | 1.1 × 10⁻³ |
| Example 7 | 3.1 | Li, B, P, O | 4.0 | 1820 | 2.2 × 10⁻³ |
| Example 8 | 3.1 | Li, B, P, O | 2.2 | 1820 | 1.2 × 10⁻³ |

### Evaluation

### Particle Size

The particle size distribution of the coated active materials was measured by “AEROTRAC II” manufactured by MicrotracBEL. Then, D₁₀ (particle size with integration of 10%), D₅₀ (particle size with integration of 50%), and D₉₀ (particle size with integration of 90%) were calculated. Table 2 shows the results. From the obtained values, the ratio of the particle sizes before and after the formation of the coating layer and the variation in the particle size of the coated active material were calculated. Table 2 shows the results. It is to be noted that the smaller the ratio of the particle sizes before and after the formation of the coating layer is, the more the aggregation of the coating particles is suppressed. As for the variation in particle size, it means that the variation is smaller as the numerical value is closer to 1.0.

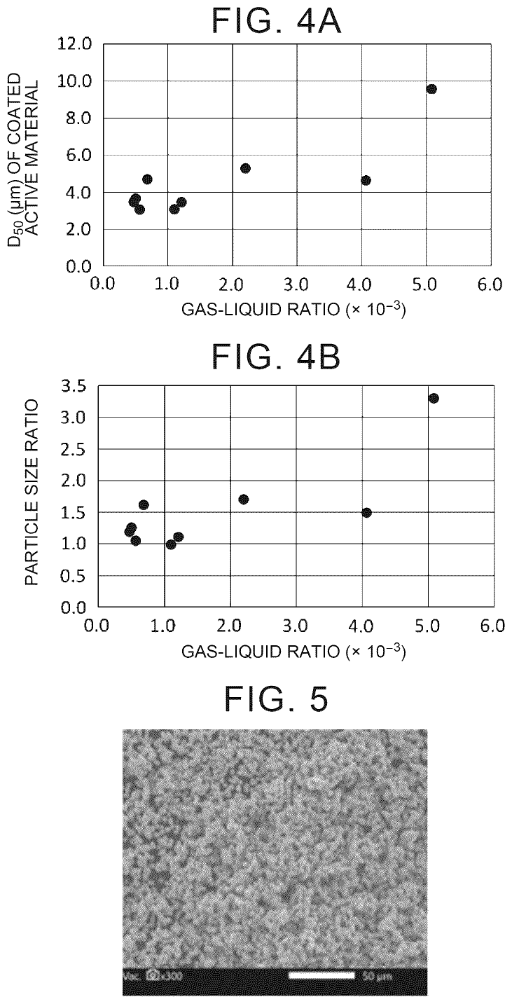

In addition, the relationship between the gas-liquid ratio and the D₅₀ of the coated active material is shown in FIG. 4A, and the relationship between the gas-liquid ratio and the ratio of the particle sizes before and after the coating layer is shown in FIG. 4B.

### Coverage Rate

The coverage of the respective coated active materials was measured by X-ray photoelectron spectroscopy (XPS). Specifically, surface-element analysis of the coated active material was performed by an X-ray photoelectron spectrometer (manufactured by ULVAC-PHI, PHIX-tool). The pass energy was 224 eV, and narrow scan analyses were performed. Then, the element ratio was calculated from the intensity of the detected Lils, Ni2p3, Co2p3, Allp, Bls by analysis software (MultiPak, manufactured by ULVAC-PHI). Then, [%] of (P+B)/(P+B+Ni+Co+Al) was determined as the coverage. Table 2 shows the results.

### Microscopic Observation

The coated active material prepared in Example 1 was imaged by scanning-electron microscopy (SEM). Show in FIG. 5

### Battery Resistance

As described below, an evaluation battery (all-solid-state battery) having a positive electrode current collector, a positive electrode active material layer, a solid electrolyte layer, and a negative electrode active material layer was prepared using the coated active materials of Comparative Example 1 and Examples 1 to 8.

A coated active material (positive electrode active material), a sulfide solid electrolyte (10LiI-15LiBr-75Li₃PS₄), a conductive material (VGCF), a binder (SBR), and a dispersing medium (heptane) were mixed by an ultrasonic homogenizer to prepare a positive electrode slurry. The ratio of the positive electrode active material to the sulfide solid electrolyte was defined as “positive electrode active material/sulfide solid electrolyte=6/4 (volume ratio)”. The proportion of the conductive material and the binder was 3 parts by mass with respect to 100 parts by mass of the positive electrode active material. It was. The positive electrode slurry was coated on the positive electrode current collector (Al foil) and dried by a hot plate at 100° C. for 30 minutes. Thus, a positive electrode having a positive electrode active material layer and a positive electrode current collector was obtained. An all-solid-state battery was fabricated using this positive electrode. As for the negative electrode active material, graphite was used, and as the solid electrolyte in the negative electrode active material layer and the solid electrolyte, the same sulfide solid electrolyte as that in the positive electrode active material layer was used.

The open-circuit voltage (OCV) was adjusted to 2.03 V for the respective evaluated batteries produced. Then, constant current discharge was performed, the voltage drop in 5 seconds was divided by the current amount, and the battery resistance was measured. The discharging current rate was set to 2.5 C. Comparative Example 1 was relatively evaluated as a reference (1.00). Table 2 shows the results.

TABLE 2

| | Particle Size (μm) | | | | | | | |
|---|---|---|---|---|---|---|---|---|
| | Active | Coated Active | | | Particle- | Variation | | Battery |
| | Material | Material | | | Size | in Particle | Coverage | Resistance |
| | A | α | β | γ | Ratio | Size | Rate | (Relative |
| | (D₅₀) | (D₁₀) | (D₅₀) | (D₉₀) | (β/A) | (β/(γ − α)) | (%) | Value) |
| Comparative | 2.9 | 2.38 | 9.56 | 19.02 | 3.3 | 0.57 | 98 | 1.00 |
| Example 1 | | | | | | | | |
| Example 1 | 2.9 | 2.01 | 3.45 | 6.87 | 1.2 | 0.71 | 98 | 0.51 |
| Example 2 | 2.9 | 2.19 | 4.69 | 11.04 | 1.6 | 0.53 | 97 | 0.60 |
| Example 3 | 2.9 | 1.89 | 3.04 | 5.32 | 1.0 | 0.89 | 90 | 0.48 |
| Example 4 | 2.9 | 1.87 | 3.65 | 6.97 | 1.3 | 0.72 | 97 | 0.60 |
| Example 5 | 3.1 | 1.93 | 4.63 | 12.57 | 1.5 | 0.44 | 96 | 0.50 |
| Example 6 | 3.1 | 1.80 | 3.06 | 6.71 | 1.0 | 0.62 | 95 | 0.48 |
| Example 7 | 3.1 | 1.96 | 5.28 | 13.11 | 1.7 | 0.47 | 93 | 0.52 |
| Example 8 | 3.1 | 1.91 | 3.44 | 7.83 | 1.1 | 0.58 | 96 | 0.52 |

As shown in Tables 1, 2, and FIGS. 4A, 4B, by setting the gas-liquid ratio to be equal to or less than 5.0×10⁻³, aggregation can be suppressed, and a coated active material having a small D₅₀ can be produced. In addition, it was confirmed that the battery resistance can be remarkably suppressed when the coated active material is used. In addition, in the comparative examples and the examples, both the variation in particle size and the coverage ratio were good, and no significant difference was observed. In particular, as shown in FIG. 5, it was confirmed that particles having a more uniform size were obtained in the coated active material of Example 1.

### Reference Example 1

A coating solution containing an oxide solid-electrolyte containing Li, Nb and an O element was prepared in the following manner.

A 30 wt % hydrogen peroxide 870.4 g was added to the vessel, 987.4 g of ion-exchanged water, and 44.2 g of niobate (Nb₂O₅·3H₂O (Nb₂O₅ water content 72%)) were added. Next, a 28 wt % ammonia-water 87.9 g was added to the vessel. Then, ammonia water was added and stirred to obtain a transparent solution. To the resulting clear solutions was added lithium hydroxide monohydrate (LiOH H₂O) 10.1 g. As a result, a complex solution containing a peroxo complex of niobium and lithium ions was obtained as a coating liquid.

A coated active material was obtained in the same manner as in Example 1, except that the coating liquid was used and the coating layer forming conditions were changed as shown in Table 3.

### Reference Examples 2 to 7

A coated active material was prepared in the same manner as in Example 1, except that the particle size (D₅₀) and the gas-liquid ratio of the active material were changed as shown in Table 3.

Particle size and coverage was measured in the same manner as described above for each coated active material obtained in Reference Example. Table 4 shows the results of Example 1.

TABLE 3

| | | | Coating Layer | | |
|---|---|---|---|---|---|
| | | | Forming Conditions | | |
| | Active | | | Air | |
| | Material | Solid | Water | Flow | Gas- |
| | Particle | Electrolyte | Supply | Rate | Liquid |
| | Size | Contained | X | Y | Ratio |
| | (D₅₀: μm) | Element | (L/min) | (L/min) | (X/Y) |
| Reference | 2.9 | Li, Nb, O | 0.13 | 24 | 5.4 × 10⁻³ |
| Example 1 | | | | | |
| Reference | 5.1 | Li, B, P, O | 0.13 | 24 | 5.4 × 10⁻³ |
| Example 2 | | | | | |
| Reference | 4.3 | Li, B, P, O | 0.90 | 100 | 9.0 × 10⁻³ |
| Example 3 | | | | | |
| Reference | 4.3 | Li, B, P, O | 0.90 | 50 | 1.8 × 10⁻² |
| Example 4 | | | | | |
| Reference | 4.3 | Li, B, P, O | 0.15 | 320 | 4.7 × 10⁻⁴ |
| Example 5 | | | | | |
| Reference | 4.3 | Li, B, P, O | 0.15 | 68 | 2.2 × 10⁻³ |
| Example 6 | | | | | |
| Reference | 4.3 | Li, B, P, O | 0.18 | 320 | 5.6 × 10⁻⁴ |
| Example 7 | | | | | |
| Reference | 4.3 | Li, B, P, O | 0.15 | 220 | 6.8 × 10⁻⁴ |
| Example 8 | | | | | |
| Example 1 | 2.9 | Li, B, P, O | 0.15 | 320 | 4.7 × 10⁻⁴ |

TABLE 4

| | Particle Size (μm) | | | | | | |
|---|---|---|---|---|---|---|---|
| | Active | Coated Active | | | Particle- | Variation | |
| | Material | Material | | | Size | in Particle | Coverage |
| | A | α | β | γ | Ratio | Size | Rate |
| | (D₅₀) | (D₁₀) | (D₅₀) | (D₉₀) | (β/A) | (β/(γ − α)) | (%) |
| Reference | 2.9 | 1.96 | 3.25 | 5.86 | 1.1 | 0.83 | 87 |
| Example 1 | | | | | | | |
| Reference | 5.1 | 3.30 | 6.02 | 12.32 | 1.2 | 0.67 | 93 |
| Example 2 | | | | | | | |
| Reference | 4.3 | 2.91 | 5.60 | 1242 | 1.3 | 0.59 | 96 |
| Example 3 | | | | | | | |
| Reference | 4.3 | 2.59 | 6.00 | 15.74 | 1.4 | 0.46 | 95 |
| Example 4 | | | | | | | |
| Reference | 4.3 | 2.78 | 4.65 | 7.23 | 1.1 | 1.04 | 97 |
| Example 5 | | | | | | | |
| Reference | 4.3 | 2.99 | 5.11 | 8.24 | 1.2 | 0.97 | 83 |
| Example 6 | | | | | | | |
| Reference | 4.3 | 2.60 | 4.52 | 7.17 | 1.1 | 0.99 | 76 |
| Example 7 | | | | | | | |
| Reference | 4.3 | 2.95 | 5.02 | 8.05 | 1.2 | 0.98 | 95 |
| Example 8 | | | | | | | |
| Example 1 | 2.9 | 2.01 | 3.45 | 6.87 | 1.2 | 0.71 | 98 |

As shown in Table 3 and Table 4, in Reference Example 1 in which the oxide solid electrolyte did not contain P, the granulation of the active material was suppressed even when the gas-liquid ratio was increased. As described above, it was confirmed that granulation of the active material is a specific problem when the coating layer contains P. In addition, in Reference Examples 2 to 8, it was confirmed that the particle size ratio was as low as in Example, and that the granulation itself was suppressed even if the particle size of the active material was increased. Further, even when an active material having a relatively large D₅₀ is used, it was confirmed that the D₅₀ of the coated active material can be reduced by setting the gas-liquid ratio to 5.0×10⁻³ or less. It is presumed that a thin coating layer could be formed by reducing the gas-liquid ratio.

What is claimed is:

1. A coated active material comprising an electrode active material and a coating layer that coats the electrode active material, wherein:
the coating layer contains an oxide solid electrolyte containing an Li element, a P element, and an O element; and
a particle size (D₅₀) of the coated active material is 5.5 μm or less.

2. The coated active material according to claim 1, wherein the particle size (D₅₀) is 1.0 μm or more.

3. The coated active material according to claim 1, wherein the oxide solid electrolyte further contains a B element or an La element.

4. A coated active material production method of producing the coated active material according to claim 1, the coated active material production method comprising:
preparing a slurry containing the electrode active material, the oxide solid electrolyte, and a solvent for dissolving the oxide solid electrolyte; and
forming the coating layer by a spray drying method of jetting the slurry with atomized air to be dried, wherein
a gas-liquid ratio in the spray drying method is 5.0×10⁻³ or less.

5. The coated active material production method according to claim 4, wherein the atomized air has a flow rate of 60 L/min or more.
